(19) United States
(12) Patent Application Publication
(10) Pub. No.: US 2005/0231490 A1
(43) Pub. Date: Oct. 20, 2005

(54) Thin display device

(76) Inventors: Gady Golan, Hod-HaSharon (IL); Dany Moskovitch, Haifa (IL)

Correspondence Address: Anthony Castorina, Suite 207, 2001 Jefferson Davis Highway, Arlington, VA, 22202, US

(21) Appl. No.: 10/525,343

(22) PCT Filed: Aug. 21, 2003
(86) PCT No.: PCT/IL03/00695

§ 371 Date: Feb. 22, 2005

Related U.S. Application Data
(60) Provisional application No. 60/404,918, filed on Aug. 22, 2002.

(51) Int. Cl. G09G 5/00

(52) U.S. Cl. 345/204

(57) ABSTRACT

A pixel-based electronic display comprising a plurality of pixels, the pixels being dots of light emitting diode material. The dots are formed into the segments of a numeric display to make a low power flexible display suitable for use in smart cards. Also disclosed is a smart card having such a display as well as a pressure sensitive input arrangement and a thin flexible battery, and a method of manufacture of the display.

### FIELD OF THE INVENTION

The present invention relates to display devices and more particularly but not exclusively to thin display devices suitable for use in smart cards and like technologies.

### BACKGROUND OF THE INVENTION

The smart card is a thin device having the dimensions of a credit card, that is intended to fit in pockets and wallets and yet be capable of carrying out computing operations. The specification for a smart card is that it must be of approximately the dimensions of the credit card it replaces, that is very restricted particularly in the depth dimension and it must be flexible, so as not to break or have its functions impaired under the stresses and strains typical of a user's pocket. The restricted depth dimension of the smart card as well as the need for flexibility makes the smart card a relatively tough engineering environment. A further difficulty with a smart card is the difficulty in providing it with power. Conventional batteries are neither thin enough nor flexible, and thus current smart cards are generally powered over external connections.

Displays for smart cards are known. The current art involves LCD based displays, however these have two major disadvantages. The LCDs are not flexible and secondly the material from which they are made, benzene ring material, is generally regarded as carcinogenic. Other possibilities for display devices are luminescent materials and light emitting diodes, (LED). Luminescent materials are used in displays for smart cards.

Luminescent Materials

Flat and flexible light emission may be achieved in several ways. The first is by using luminescent materials.

Luminescent materials are materials in which hole-electron generation, or excitation of deep impurity electrons from their normal low-energy level, to a higher and empty impurity level (with both in the forbidden gap), is followed by a return to equilibrium via photon emission in the visible spectral range. The exact wavelength, i.e. color, is a characteristic of the material or impurity. The original excitation can be caused by absorption of high-energy photons (photoluminescence) or by bombardment with high-energy electrons (cathode-luminescence). Recombination and photon emission usually take place in several stages and materials capable of exhibiting such luminescence are called phosphors. ZnS is such a semiconductor, to which Cu, Ag, or Mn impurities are added to bring the emission into the visible spectrum. Each of the above materials produces a result with a different color. Color screens may be made with different pixels using different impurities.

In WO Pat. Application No. 9,631,730 (Huwitz) an illuminated protective encapsulation for phosphor is disclosed. It comprised a protective shell with a power unit in it. The EL lamp is secured to the shell and is operated by a power unit, providing intermittent illumination.

In one JP Pat. Application assigned to Nippon Kasei K K a road sign for pedestrians or vehicles is disclosed. A pair of ultrasonic sensors are arranged on the pavement, and send a signal to a control unit which controls the power feed to an electroluminescent (EL) element. A solar battery serves as the power supply.

U.S. Pat. No. 5,359,341 (Hutchings) disclosed a power supply for sequentially energizing segments of an EL panel to produce animated displays. An electronically programmable EPROM programmed with a predetermined sequence for an EL graphic display controls the sequence of powering (or not powering) of each segment of the EL display.

Light Emitting Diodes (LED)

Light emitting diodes (or LEDs) utilize the recombination of excess carriers, injected in a forward biased diode, to obtain light emission for display purposes. In the case of direct band-gap semiconductors such as GaAs, both conduction electrons and holes have very low momentum values. Direct radiative recombination of electrons and holes therefore occurs with high probability and such semiconductors may therefore be used for light generation. In a forward biased GaAs diode the injected carriers recombine as described with relatively high probability, but the emission is in the near I.R. (NIR) range, that is at about 0.85 microns. The radiation intensity is proportional to the concentration of excess minority carriers and therefore to the forward current. GaAs LEDs cannot be used directly for displays since the wavelength is beyond the visible range. But the compound semiconductor GaAsxP1-x (Gallium Arsenide Phosphide) has a band-gap which depends on x, the Arsenic percentage. At x=0.44 the band-gap is still direct but the emitted light is red and visible.

The parallel connection of many LEDs may be used to display numbers and letters. A common way to display a whole number is by the seven-segment system, in which the numerals 0 to 9 are represented by illumination of different combinations of the segments of a FIG. 8. Each of the seven segments may be a single LED or may be composed of several LEDs arranged in a line. A digital control system is used to direct the current to the desired segment.

The advantages of LEDs compared to other kinds of illumination are their high efficiency, long operating lifetimes, mechanical sturdiness, and ability to operate from low voltage supplies which are compatible with transistor circuits. Nevertheless conventional LED panels are not sufficiently flexible to be entirely suitable for smart card use, and the power requirement is still too high. More particularly, an LED display is a bulk device, which is both thick and rigid in terms of the requirements of the smart card, Thus it has never been used as a readout display for smartcard applications. LED displays require depth which simply is not available in the thin environment of the smart card.

In view of the above, whilst the possibility exits, most current smart cards do not in fact have a display. Indeed current smartcards typically consist only of passive built-in chips with flash memories, and require an external stationary energy source for Read/Write processes and for status verification processes.

It is an object of the present invention to solve the above-described problems and to provide a display for a smart card that is devoid of the above problems.

### SUMMARY OF THE INVENTION

According to a first aspect of the present invention there is provided a pixel-based electronic display comprising a plurality of pixels, wherein the pixels respectively comprise dots of light emitting diode material.

In one embodiment, the pixels are arranged as segments of at least one seven-segment numeric display.

In another embodiment, the light-emitting diode dots are bonded to at least one underlying PCB.

The dots may be wire bonded.

For purposes of control, all of the pixels in any one of the segments may be commonly wired.

Preferably, the light emitting diode dots are of a thickness not exceeding 200 microns.

In one embodiment the underlying PCB is of a thickness not exceeding 200 microns, and preferably does not exceed 150 microns.

The pixels may be configured to provide a brightness of substantially 4 Cd/cm² at a power of substantially 1.5 mA.

Preferably, the pixels are configured to provide a brightness of substantially 4 Cd/cm² at a power of substantially 1.5 mA.

The display may be incorporated into a smart card or like thin environment where flexibility is important. In such circumstances a thin flexible battery may be used as a power supply.

The display may be associated in the smart card with one or more pressure sensors as input devices for the card, so that a smart card is provided having both input and display capability for user interaction.

According to a second aspect of the present invention there is provided a thin computing device comprising electronic processing functionality and a display screen, wherein the display screen is a pixel-based display screen comprising a plurality of pixels, wherein the pixels respectively comprise dots of light emitting diode material.

The thin computing device may comprise a thin flexible battery for powering at least the display screen.

The device may comprise a touch panel associated with the computing functionality for allowing a user to interact with the device.

The device may comprise timing circuitry associated with the display screen, for energy management of the display screen.

According to a third aspect of the present invention there is provided a method of manufacturing a flexible low power display comprising:
providing pixel dots of LED material,
bonding the dots to a PCB having a backing material, and
removing the backing.

Preferably, the providing pixel dots comprises using a masking procedure.

Preferably, the pixel dots comprise a layer not exceeding 200 microns of the LED material.

In one embodiment, the LED material is doped Galium phosphide.

In one embodiment, the PCB is of a thickness not exceeding 200 microns.

In a further embodiment, the PCB is of a thickness not exceeding 150 microns.

The backing layer is preferably of a thickness of substantially 300 microns.

The method may further comprise coating the display with a layer of epoxy resin.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is a simplified diagram illustrating a single segment of a seven segment numeric display which segment comprises LED pixel dots according to a preferred embodiment of the present invention;

FIG. 2 is a simplified side view of a pixel dot from FIG. 1 mounted on a PCB.

FIG. 3 is a simplified schematic layout diagram of a smart card according to a preferred embodiment of the present invention incorporating pixel dot LED segments according to FIG. 1;

FIG. 4 is a schematic diagram illustrating three smart cards to which the present embodiments have been applied;

FIG. 5 is a schematic diagram of plan view of a smart card according to the present embodiments, showing locations of the screen and battery;

FIG. 6 is a simplified diagram illustrating a possible smart card layout according to an embodiment of the present invention;

FIG. 7 is a simplified wiring diagram for a smart card according to a preferred embodiment of the present invention;

FIG. 8 is a simplified diagram showing pin layouts for a smart card according to a preferred embodiment of the present invention,

FIGS. 9a-9f show internal wiring of PCB layers for the segments for use in a display device according to a preferred embodiment of the present invention; and

FIGS. 10a-10h are simplified diagrams showing a display screen according to the embodiments of the present invention during sequential stages of a data readout operation.

### DESCRIPTION OF THE PREFERRED EMBODIMENTS

The present embodiments provide an LED display screen made up of pixel type dot diodes. Typically the display screen comprises several of the standard seven segment numeric displays, each arranged to display a single digit, and the segments may be augmented with decimal points and the like. The segments themselves are constructed of pixels. The pixel type dot diodes are thinner than conventional LED segments, are in themselves more flexible than prior art LED segments, and are mounted on thinner, more flexible PCBs. As will be explained below, segments made up of such pixels require less power to operate than conventional LED segments. The dot diodes are preferably wire bonded to thin PCBs.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

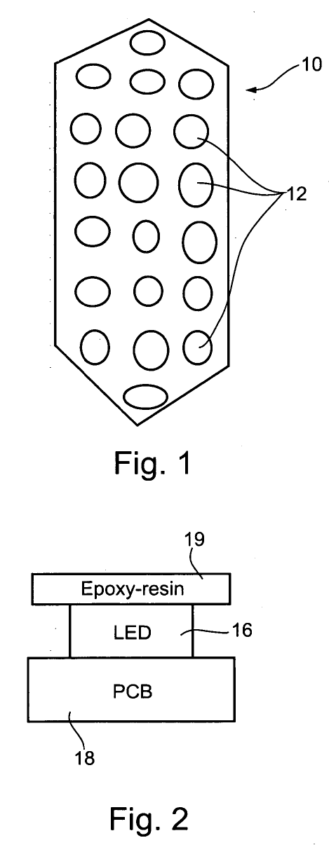

Reference is now made to FIG. 1, which is a simplified diagram illustrating a pixel-based electronic display segment according to a first preferred embodiment of the present invention. Display segment 10 is a typical segment of a seven segment numerical display, but instead of being a uniform segment, it comprises individual pixel dots 12 each of which is constructed of a thin layer of light emitting diode material coated with epoxy resin.

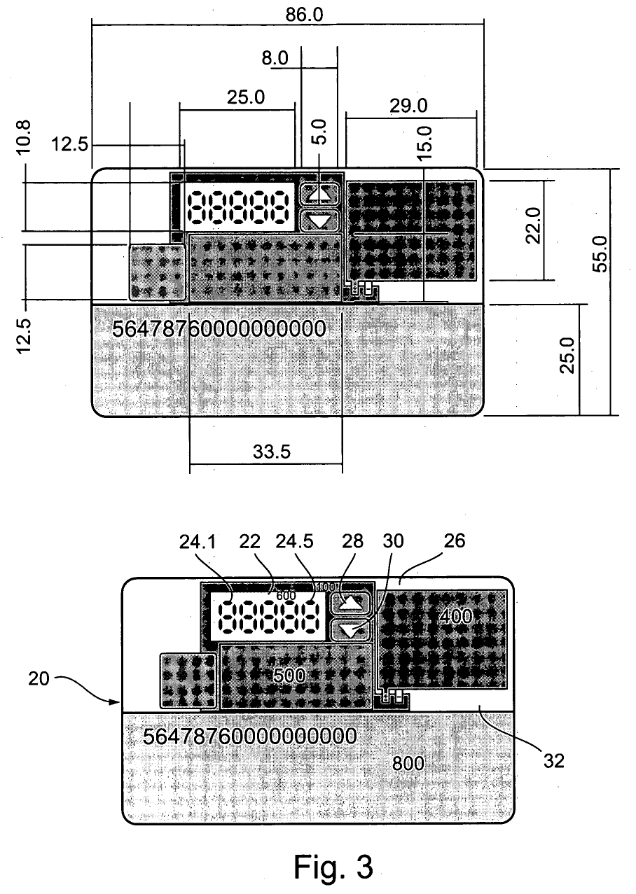

Reference is now made to FIG. 2, which is a simplified diagram illustrating a single light-emitting diode dot 16 bonded to an underlying PCB 18. The construction is preferably coated with a layer 19 of epoxy resin. Preferably, the light emitting diode dots are wire-bonded to the underlying PCB. Preferably, the light emitting diode dots are of a thickness in the order of magnitude of 200 microns. Such a thickness of the LED material, combined with the size of the dot, yields properties which are desirable in the present context. In particular the LED is able to operate effectively at a current of 1.5 mA. That is to say a segment constructed from such dots is able to provide an illumination level of around 4 Cd/cm² at the above-mentioned power. Furthermore, the combination of the above mentioned thinness and the size of the dot provides a material that is flexible, that is to say the dot is not damaged by flexing of the card. The PCB 18 is preferably also thin, and in one embodiment is 200 microns or even as thin as 150 microns.

The LED display is electrically equivalent to a semiconductor diode, and is coated on top with an epoxy resin. The segment structure consists of a dot LED matrix, assembled on a thin and flexible PCB. The individual pixel dots are constructed by a masking process and glued to the PCB in the segment structure.

In one preferred embodiment the LED dot size is O.24×0.24 mm. The material used for the LED dots is metalized AlGaAs/GaAs. As explained, the method of assembly of the LEDs onto the PCB is wire bonding. A preferred bonding material is silver epoxy, and wire bonding is carried out using aluminum wire. The finish for the PCB is FR 4.

As discussed in the background, light-emitting diodes utilize the recombination of excess carriers, injected in a forward biased diode, to obtain light emission for display purposes. In the case of direct band-gap semiconductors such as GaAs, both conduction electrons and holes have very low momentum values. Direct radiative recombination, which leads to photon emission, is therefore highly probable and it is such semiconductors that are used for light generation. In a forward biased GaAs diode the injected carriers recombine relatively, but photon emission is in the near I.R. (NIR) range, that is about 0.85 microns. The radiation intensity is proportional to the concentration of excess minority carriers and therefore to the forward current. GaAs LEDs cannot be used as such for displays since the wavelength is beyond the visible range. However, modification by doping with an impurity can shift the wavelength of the emitted light. Thus, the compound semiconductor GaAsxP1-x (Gallium Arsenide Phosphide) has a band-gap which depends on x, the percentage of arsenic. At x=0.44 the band-gap is still direct but the emitted light is red and visible.

The dots of the present invention may thus comprise gallium arsenide Phosphide, or any other suitable material. The segments each comprise a large number of dots which are commonly wired, that is commonly controlled. That is to say either the segment as a whole is switched on or off. In alternative embodiments, the pixels may be arranged into different numbers of segments or into smaller segments, for example to display alphabetic as well as numerical symbols. In a further preferred embodiment, the individual pixels may be separately addressable to provide a graphic display. In a further alternative embodiment, different impurities may be used to construct different dots, which consequently emit at different wavelengths. Dots of each wavelength are controlled together to give a color display ability to the LED segments, in a similar way to that in which colored pixels are controlled separately in a conventional color screen.

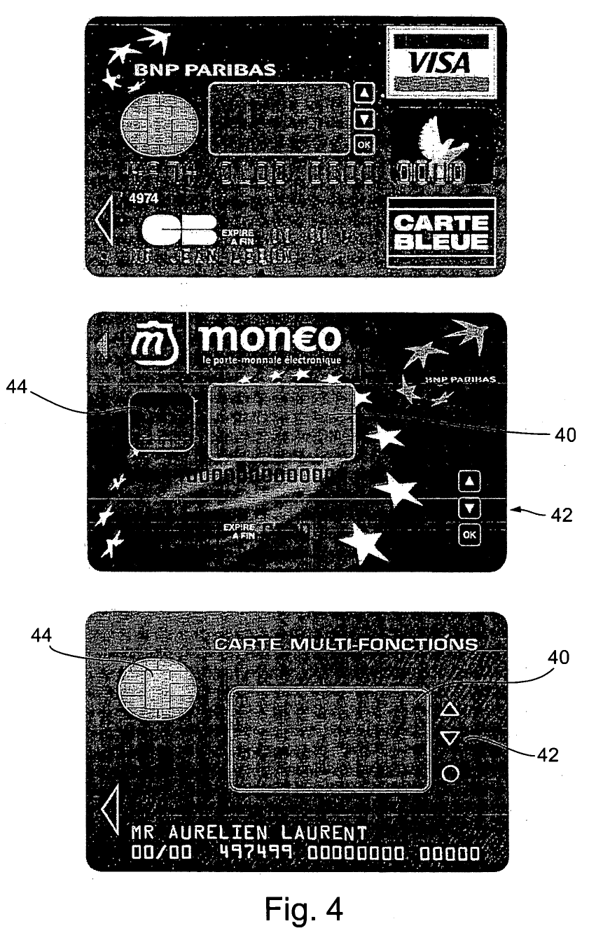

Reference is now made to FIG. 3, which is a simplified diagram showing the principle features of a smart card according to a preferred embodiment of the present invention. In FIG. 3, a smart card 20 comprises a display 22 having five sets of seven-segment numerals 24.1 . . . 24.5. The card further comprises an input pad arrangement 26 comprising two input pads, one 28 indicated with an up arrow and one 30 indicated with a down arrow. A substantially flexible thin battery 32 provides an internal power source for the smart card.

The input panels 28 and 30 are preferably pressure pads. The thin flexible battery 32 can be any suitable battery. A number of suitable devices are mentioned below but numerous suitable devices are available or will be available in the near future and the skilled person will be aware of the advantages and disadvantages of each.

U.S. Pat. No. 5,731,105 (Fleischer et al.), incorporated herein by reference, discloses a non-liquid electrolyte containing a battery power source which operates efficiently at room temperature. The battery includes (1) a non-liquid electrolyte in which protons are mobile. (2) an anode active material based on an organic compound which is a source of protons during battery discharge, or an anode active material including a metal whose cation can assume at least two different non-zero oxidation numbers, and (3) a solid cathode including a compound which forms an electrochemical battery couple with the anode. Anode and Cathode active materials can be chosen so that the battery has the feature that electrochemical reactions at the anode and cathode are at least partially reversible. The battery can be fabricated in any desired shape or size without any special production precautions.

U.S. Pat. No. 5,382,481 (Fleischer et al.), incorporated herein by reference, discloses an all solid state battery power source which operates efficiently at room temperature. The battery includes (1) a solid state electrolyte in which protons are mobile, (2) an anode active material based on an organic compound which is a source of protons during battery discharge, or an anode active material including a metal whose cation can assure at least two different non-zero oxidation numbers and (3) a solid cathode including a compound which forms an electrochemical battery couple with the anode. Anode and cathode active materials can be chosen so that the battery has the feature that the electrochemical reactions at the anode and cathode are at least partially reversible. The battery can be fabricated in any desired shape without any special production precautions.

See also U.S. Pat. No. 5,512,391, U.S. Pat. No. 5,580,681, all to Fleischer et al., incorporated herein by reference.

Products based on the above-cited patents include thin (0.4 mm) and flexible 25 mA-h batteries. The technology based on U.S. Pat. Nos. 5,731,105, U.S. Pat. No. 5,382,481, U.S. Pat. No. 5,512,391, and U.S. Pat. No. 5,580,681, or other batteries having similar specifications such as Varta or NTK, are incorporated into preferred embodiments of the present invention. The batteries may be incorporated as single units, or two or more batteries may be piled one on top of the other.

The flexible LED display device 22 preferably comprises:
0 at least one of a number of seven segment LED numeric displays of predetermined shape, size and color of emitted light;
1 a DC power supply as described, that is a flat and flexible battery;
2 a DC separator between the internal battery and the external one;
3 a power driver;
4 an oscillator;
5 a switching unit; and
6 a control unit.

Preferably, the oscillator provides timing control for the transaction operations of the smart card system. The DC separator separates between internal and external voltages, so that the LED segments may be activated using the switching unit. For this purpose the switching unit is programmed with On and Off controllable conditions for powering or not powering the LED segments. The control unit controls the system and output, and controls the system to provide a predetermined sequence for powering of segments. It is possible with suitable programming to provide alternating lighting or animated effects in the segments. As mentioned above, if differently doped dots are provided, then appropriate programming can provide color control.

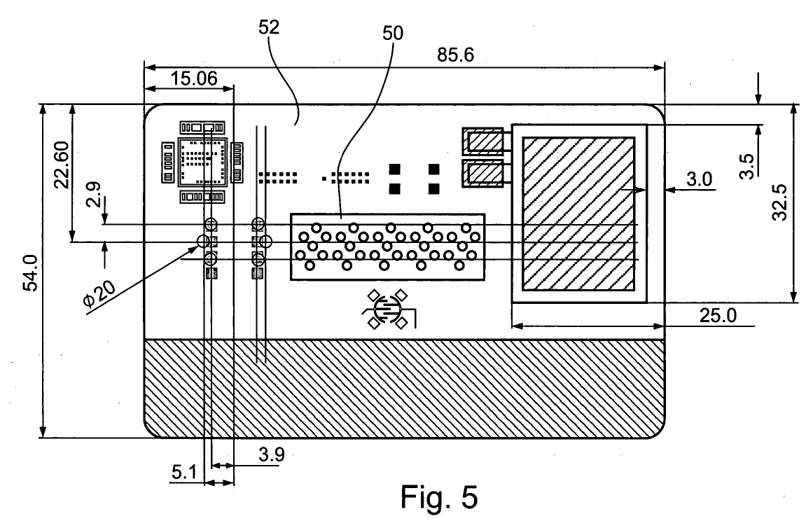

Reference is now briefly made to FIG. 4, which shows three schematics of the application of the scheme of FIG. 3 to actual smart cards. Each of the cards has an display screen 40, an input arrangement 42, and a processor chip 44. In the schematics of FIG. 4, the input arrangement 42 comprises three input pads.

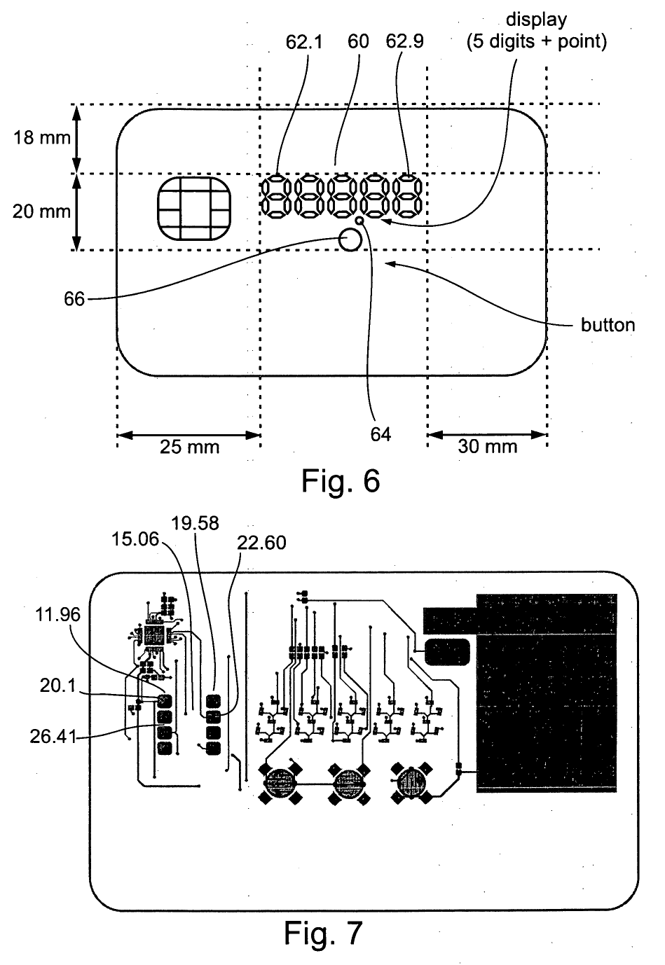

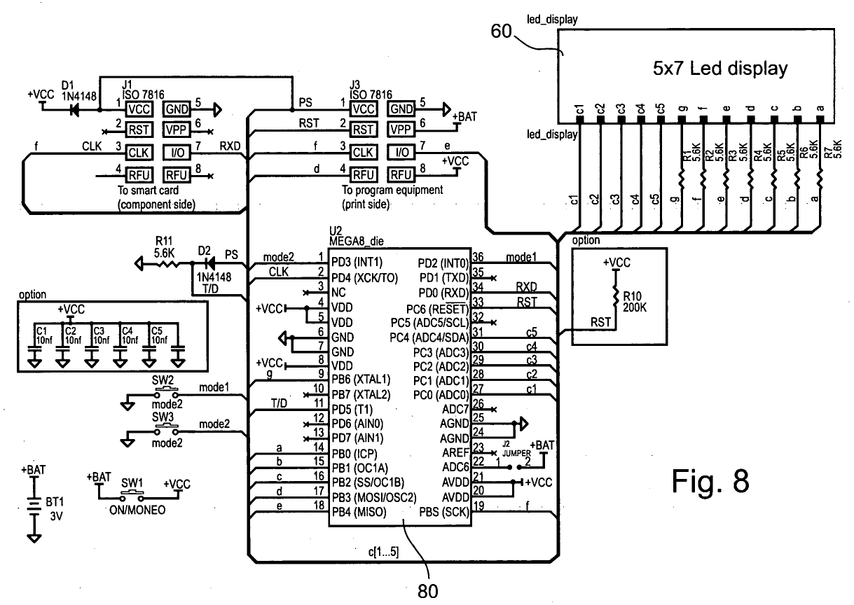

Reference is now made to FIG. 5, which is a simplified schematic diagram illustrating a flexible screen segment 50 comprising dots of LED material located on a PCB mounting 52. Reference is now made to FIG. 6, which is a simplified diagram illustrating a display screen 60 with five digits 62.1 . . . 62.5 of seven segments each and an additional segment 64 for a decimal point. An input/output button 66 is located immediately below the screen 60.

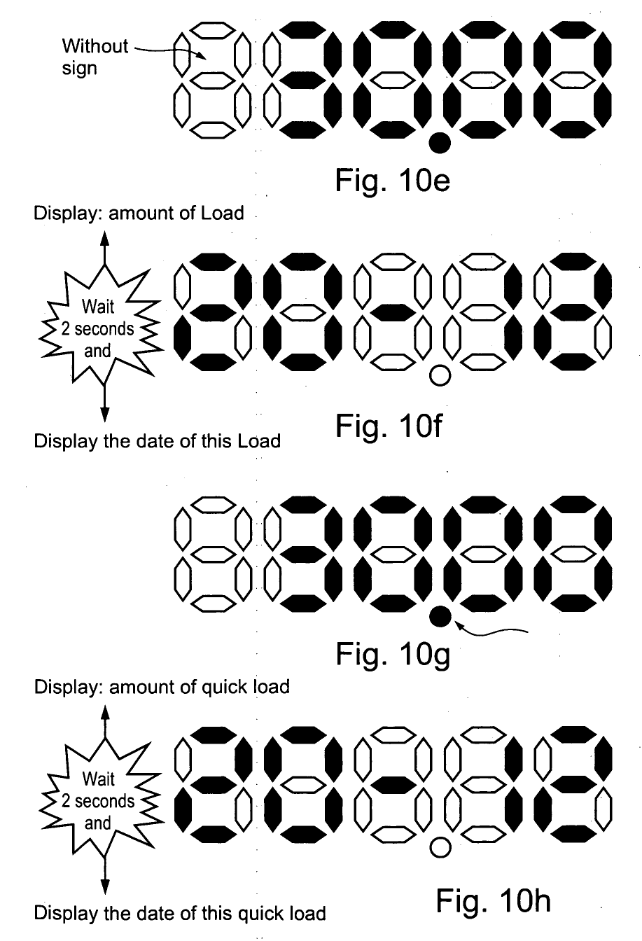

In one embodiment for operating the smart card, the screen and input button are disabled during input output operations but the numerical content of any operation is monitored by an internal register circuit. Operation of the button subsequent to an input output operation causes a number relevant to the transaction such as the transaction amount itself or the remaining balance to be displayed on the screen. Further or continued pressing of the button causes previous operations to be read out. Release of the button deactivates the screen so that power is not wasted. A more detailed discussion of data readout is given with reference to FIG. 10 below.

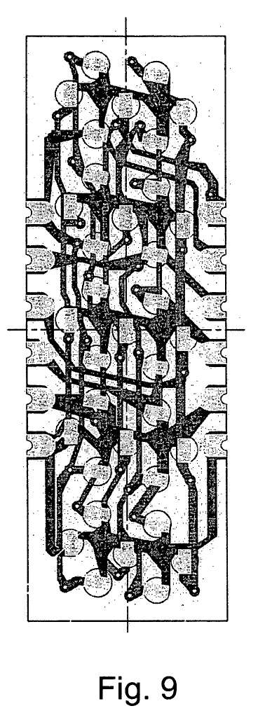

Reference is now made to FIG. 7, which is a simplified schematic diagram that illustrates an optional arrangement of a PCB layout according to ISO 7816 for an LED display device, according to the present embodiment for use in a smart cards. The PCB used is a 125 micron PCB, which is temporarily glued to a 300 microns FR-4 substrate for use during construction. The substrate layer is removed later on, prior to installation in the smart card.

In FIG. 7, the controller is in the upper left, the smart card chip is in the middle left and the three pressure regions serving as push buttons are located at the center bottom. The center middle contains the dot LED display and the battery is located on the right.

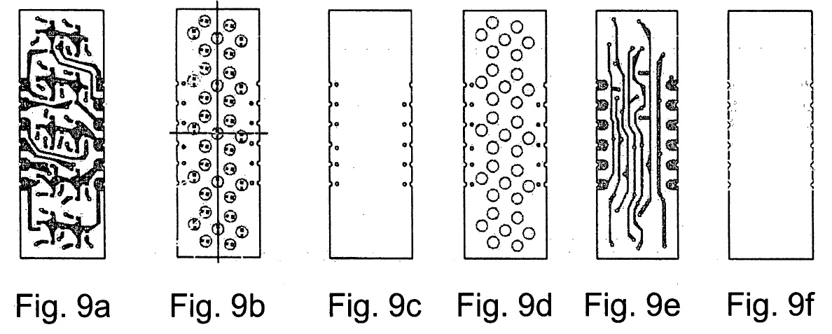

Reference is now made to FIG. 8, which is a pin layout diagram showing how the 5×7 segment LED display 60 of FIG. 6 may be connected to a microcontroller 80. The segments are connected in the same way that conventional segments are connected. The chip 80 knows only about the segments and does not know about the pixel dots. As the pixel dots are connected so that all the dots in one segment are switched together, there is no need for the chip 80 to know anything about the pixel dots. In a preferred embodiment, microcontroller 80 comprises a central Atmel™ tiny microcontroller, and there are also provided three operating switches, stabilizing tank capacitors, protecting diodes D1 and D2 and a resistor array for current limiting of the LED display.

Optionally, the internal multiplexer at the Atmel micro-controller may be replaced with other controlling hardware or even a software-based control unit. The control unit can send a constant On command, a periodical On/Off signal (blinking) or it can send sequential signals in a predetermined order to provide the animated effects referred to above. The computer program can be designed to allow end-user programming of the desired sequence of powering commands for each segment in the LED display.

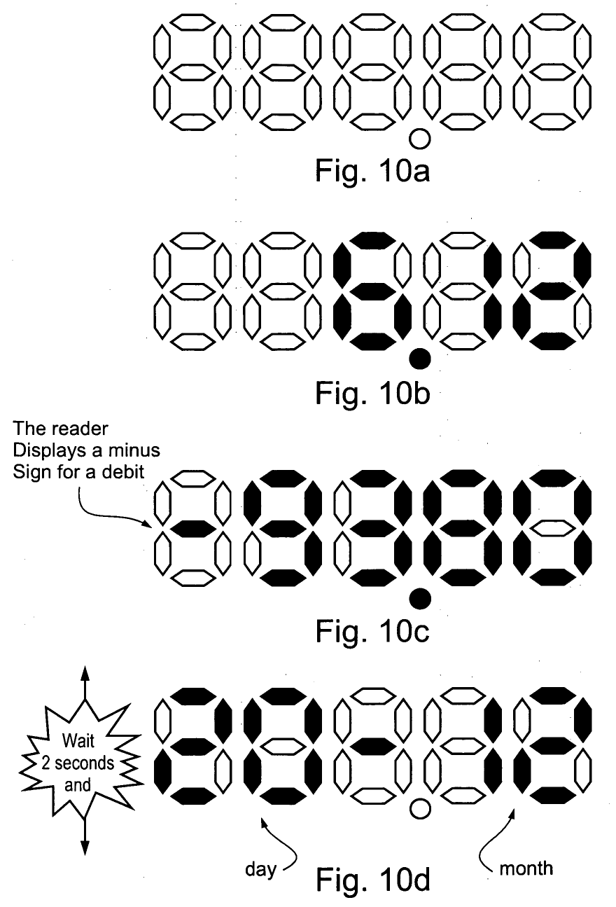

Reference is briefly made to FIGS. 9a-9f, which show PCB wiring layouts for the segments. FIG. 9 shows a multi-layer PCB within the zone of the LED display.

FIG. 9a shows the upper side of the PCB with copper conductors. FIG. 9b shows the positioning of the LEDs, two contacts being provided for each LED. FIG. 9c only defines the center zone, FIG. 9d shows an upper view of the LEDs without contacts. FIG. 9e illustrates the lower side of a PCB with copper conductors, and FIG. 9f shows a general definition of the LED display zone.

Reference is now made to FIG. 10, which shows a data readout session consisting of: balance, and a predetermined number of most recent transactions, all accompanied by dates. The data readout is preferably controlled using timing circuitry in order to conserve energy, as will be explained below.

In one embodiment, total session readout time is limited to between one and four seconds in order to save as much battery power as possible. FIG. 10a shows the basic display including the five segment-based numerals and a decimal point. FIG. 10B illustrates a current balance on the card, which is displayed after a single push of the input button. FIGS. 10c and 10d show how a transaction may be displayed using the screen. A transaction typically involves three items of information, whether it is a credit or debit, the amount and the date of the transaction. As shown in FIG. 10c a minus sign indicates that the transaction type is a debit. Initially the amount of the transaction is displayed. Subsequently the date is displayed, as shown in FIG. 10d. The transition from amount to date may be made automatically after a number of seconds, say two seconds, or it can be made upon a further depression of the input button.

FIG. 10e displays a credit or load operation. The display differs from that of the debit operation in that the amount is not preceded by a minus sign. The amount is followed by the date as shown in FIG. 10f, and the changeover from amount to date is as described above.

FIGS. 10g and 10h indicate a quick load operation. A quick load operation is an operation in which a single transaction carries out both credit and debit actions on the card. The quick load operation is useful for carrying out currency transfers in which a commission is charged. Conventionally the currency transfer and the commission would be two separate operations but the quick load combines the two in a single operations. In order to distinguish a quick load operation the decimal point blinks on and off at a predetermined rate, say 200 ms on and 200 ms off.

The smart card of the present embodiments thus preferably has the following properties:

1. Low power consumption.

2. Bright readout (typically of more than 4 Cd/cm²)

3. Easy to read under conventional illumination.

4. Flexible as required in conventional smartcard standardization.

5. Thin and flexible electronic circuitry which can feasibly be constructed at less than 0.5 mm in thickness.

6. Thin (about 0.4 mm) rechargeable or non-rechargeable flexible battery of 10 mA-h.

7. Panel typically consisting of 5 digits (0-9) and a fixed decimal point.

8. Timing circuitry for energy saving.

9. Low weight of the electrical components.

10. Can be programmed by the end-user, for example the credit card company,

11. Can become a multipurpose smart card following appropriate encoding, since the display and input arrangement allow for switching between modes and give the user some kind of intuitive feel as to what is happening. Prior art smartcards by contrast are limited to preset tasks which do not require user interaction.

12. The possibility of data input provides additional opportunity for password protection.

13. During the Read/Write process, electrical energy is drawn from the point of sale in conventional manner and not from the internal battery of the smart card.

14. The Led display materials as well as the battery are made of safe materials that are not especially hazardous to the environment and are not especially carcinogenic, as opposed to the benzene rings of the prior art LCD displays.

The flexible LED display device of the above embodiments may for example be used for commercial credit cards, personal data cards, field kits, electronic purse, receiver cards, loyalty cards and for advertisement applications.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A pixel-based electronic display comprising a plurality of pixels, wherein said pixels respectively comprise dots of light emitting diode material.

2. The pixel-based electronic display of claim 1, wherein said pixels are arranged as segments of at least one seven-segment numeric display.

3. The pixel-based electronic display of claim 1, wherein said light-emitting diode dots are bonded to at least one underlying PCB.

4. The pixel-based electronic display of claim 4, wherein said light emitting diode dots are wire-bonded to said at least one underlying PCB.

5. The pixel-based electronic display of claim 2, wherein all of said pixels in any one of said segments are commonly wired.

6. The pixel-based electronic display of claim 1, wherein said light emitting diode dots are of a thickness not exceeding 200 microns.

7. The pixel based electronic display of claim 3, wherein said underlying PCB is of a thickness not exceeding 200 microns.

8. The pixel based electronic display of claim 3, wherein said underlying PCB is of a thickness not exceeding 150 microns.

9. The pixel-based electronic display of claim 1, wherein said pixels are configured to provide a brightness of substantially 4 Cd/cm at a power of substantially 1.5 mA.

10. The pixel-based electronic display of claim 6, wherein said pixels are configured to provide a brightness of substantially 4 Cd/cm² at a power of substantially 1.5 mA.

11. The pixel-based electronic display of claim 1, incorporated into a smart card.

12. The pixel-based electronic display of claim 11, associated with a thin flexible battery within said smart card.

13. The pixel-based electronic display of claim 1, associated with at least one pressure sensor based input device.

14. A thin computing device comprising electronic processing functionality and a display screen, wherein said display screen is a pixel-based display screen comprising a plurality of pixels, wherein said pixels respectively comprise dots of light emitting diode material.

15. The thin computing device of claim 14, further comprising a thin flexible battery for powering at least said display screen.

16. The thin computing device of claim 14, wherein said display screen comprises a plurality of segments, each segment comprising a plurality of pixels wired together.

17. The thin computing device of claim 14, wherein said pixels are arranged as segments of at least one seven-segment numeric display.

18. The thin computing device of claim 14, wherein said light-emitting diode dots are bonded to at least one underlying PCB.

19. The thin computing device of claim 19, wherein said light emitting diode dots are wire-bonded to said at least one underlying PCB.

20. The thin computing device of claim 17, wherein all of said pixels in any one of said segments are commonly wired.

21. The thin computing device of claim 14, wherein said light emitting diode dots are of a thickness not exceeding 200 microns.

22. The thin computing device of claim 18, wherein said underlying PCB is of a thickness not exceeding 200 microns.

23. The thin computing device of claim 18, wherein said underlying PCB is of a thickness not exceeding 150 microns.

24. The thin computing device of claim 14, wherein said pixels are configured to provide a brightness of substantially 4 Cd/cm² at a power of substantially 1.5 mA.

25. The thin computing device of claim 21, wherein said pixels are configured to provide a brightness of substantially 4 Cd/cm² at a power of substantially 1.5 mA.

26. The thin computing device of claim 14, further comprising at least one touch panel associated with said computing functionality for allowing a user to interact with said device.

27. The thin computing device of claim 14, further comprising timing circuitry associated with said display screen, for energy management of said display screen.

28. A method of manufacturing a flexible low power display comprising:
providing pixel dots of LED material,
bonding said dots to a PCB having a backing material, and
removing said backing.

29. A method according to claim 28, wherein said providing pixel dots comprises using a masking procedure.

30. The method of claim 29, wherein said pixel dots comprise a layer not exceeding 200 microns of said LED material.

31. The method of claim 30, wherein said LED material is phosphide-doped Gallium arsenide.

32. The method of claim 28, wherein said PCB is of a thickness not exceeding 200 microns.

33. The method of claim 28, wherein said PCB is of a thickness not exceeding 150 microns.

34. The method of claim 28, wherein said backing layer is of a thickness of substantially 300 microns.

35. The method of claim 28, further comprising coating said display with a layer of epoxy resin.
